(19) United States
(12) Patent Application Publication
(10) Pub. No.: US 2024/0185143 A1
(43) Pub. Date: Jun. 6, 2024

(54) Selecting Influencer Variables in Time Series Forecasting

(71) Applicant: SAP SE, Walldorf (DE)

(72) Inventors: Nai Minh Quach, Paris (FR); David Guillemet, Paris (FR)

(21) Appl. No.: 18/061,899

(22) Filed: Dec. 5, 2022

(51) Int. Cl. G06Q 10/04; G06F 16/2458

(52) U.S. Cl. CPC G06Q 10/04; G06F 16/2474

(57) ABSTRACT

Optimizing a time series forecasting model, selects a subset of original influencer variables. An original time series forecasting model comprising an original set of influencer variables, is received. Contributions of the influencer variables to the model are calculated (optionally including regularization). Variables falling below a cumulative contribution threshold, are excluded. A first new time series forecasting model, created from the remaining variables, is stored. If the first new time series forecasting model is validated based upon a performance horizon, iteration occurs to further reduce a number of influencer variables and generate another new time series forecast model. If the first new time series forecasting model is not validated under the performance horizon, the cumulative contribution threshold is lowered to exclude fewer of the original set of influencer variables and generate another new model. A subset of original influencer variables ultimately selected for a new time series forecasting model, is output.

### BACKGROUND

Unless otherwise indicated herein, the approaches described in this section are not prior art to the claims in this application and are not admitted to be prior art by inclusion in this section.

Time series forecasting can be a valuable to predict future behavior of complex systems. Such forecasting may be achieved by a time series forecasting model that considers a number of different influencer variables.

Elastic-net linear regression is one type of time series forecasting model. Another type of time series forecasting model is L1 trend filtering.

### SUMMARY

Embodiments relate to systems and methods that optimize a time series forecasting model, by selecting a minimum number of influencer variables. An original time series forecasting model comprising an original set of influencer variables is received. Contributions of the original set of influencer variables to the original time series forecasting model are calculated. Influencer variables falling below a cumulative contribution threshold, are excluded. A first new time series forecasting model, created from the remaining influencer variables, is stored. If the new time series forecasting model is validated based upon a performance horizon, iteration occurs to further reduce a number of influencer variables and generate another new time series forecasting model. If the new time series forecasting model is not validated under the performance horizon, the cumulative contribution threshold is lowered to exclude fewer of the original set of influencer variables and generate another new time series forecasting model. A subset of original influencer variables ultimately selected for a new model, is output. In some embodiments, accuracy in calculating influencer variable contribution may be enhanced through regularization.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIGS. 3A-3B list influencer variables by increasing model contribution according to a first example.

FIG. 4 shows application of two phase variable selection in the first example

FIG. 5 shows a simplified flow diagram of variable selection in the first example.

FIG. 6 shows a listing of events for variable selection in to the first example.

FIG. 7 is a table showing experiments conducted as part of a second example.

FIGS. 8-10 are tables showing performance results for the second example.

FIG. 11 illustrates hardware of a special purpose computing machine configured to implement time series variable selection according to an embodiment.

FIG. 12 illustrates an example computer system.

### DETAILED DESCRIPTION

Described herein are methods and apparatuses that implement selection of influencer variables for a time series forecasting model. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

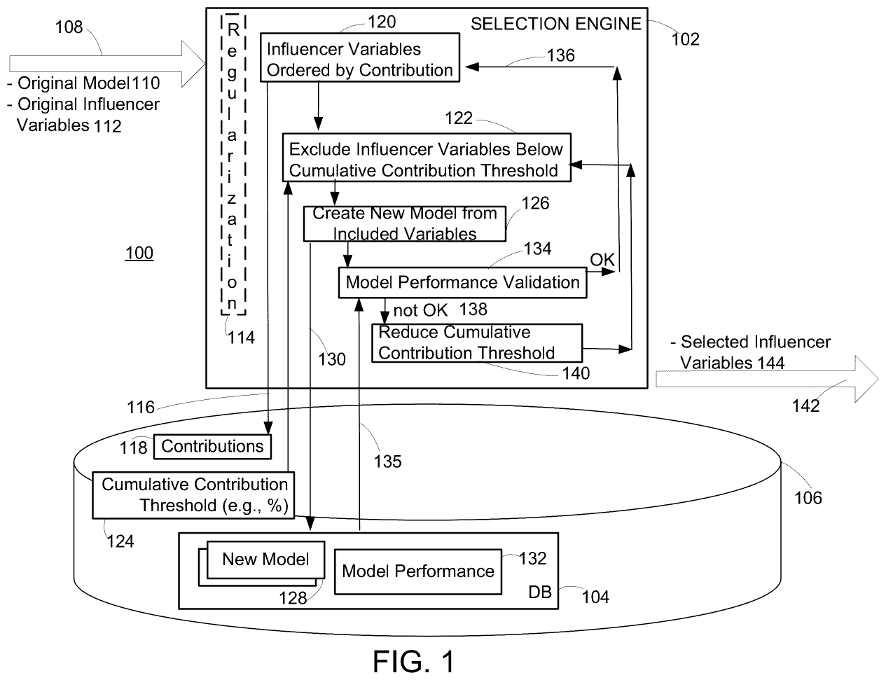

FIG. 1 shows a simplified view of an example system that is configured to implement time series variable selection according to an embodiment. Specifically, system 100 comprises a selection engine 102 that is in communication with a database 104 located in a non-transitory computer readable storage medium 106.

The selection engine is configured to receive as input 108, an original time-series forecasting model 110 that considers a set of original influencer variables 112. In general, a general time series forecasting model aims at forecasting the future of a numerical value (target variable) based upon data known at the time the forecasting takes place (input variables).

Input variables may comprise at least the following two different types of values:
the past and present values of the target variable,
the values of the influencer variables.
   The forecasting model uses the information provided by those input variables, to output the target variable for a specific time period in the future.

In time-series forecasting, linear regression can be used to estimate the different components of the time-series (such as the trend or the cycles). Accordingly, one specific type of time-series forecasting model is elastic-net regression, an enhanced version over ordinary linear regression.

A goal of elastic-net regression is to improve the accuracy of the linear regression by allowing one or more of the following:
a better generalization of the model, by reducing a risk of overfitting (e.g., the model is less sensitive to outliers in the input data);
a better discrimination of the input variables, by adjusting their weights in the forecasting process (e.g., the model could be simpler with less highly effective input variables).

Another specific type of time-series forecasting model is L1 trend filtering. L1 trend filtering is piecewise linear regression. There, if the data follow different linear trends over different regions of the data, the linear regression function may be modeled in parts.

One possible benefit of L1 trend filtering over classical linear regression, is the capacity to capture regime changes. In the case of time-series forecasting of company revenue, for example, revenue could change drastically as between a first (pre-acquisition) regime, and a second (post-acquisition) regime.

FIG. 1 shows that optionally, the selection engine may perform regularization 114 upon the influencer variables. Two types of regularization are ridge and lasso.

The selection engine calculates and stores 116 the contributions 118 of the influencer variables to the model. One measure of contribution may be importance.

The selection engine orders 120 the variables according to their model contribution. Then, the selection engine excludes 122 those influencer variables whose cumulative contribution falls below a threshold 124 (that may be expressed as a %).

Next, the selection engine creates 126 new model 128 from the remaining (non-excluded) influencer variables. The selection engine stores 130 the new model in the database.

Then, the selection engine determines performance of the new model according to a performance metric 132. The selection engine performs validation 134 of the new model by referencing 135 whether its performance meets a horizon level.

If the new model is validated, in an iterative manner 136 the selection engine determines the contributions of the remaining influencer values, excludes those falling below the threshold, creates another new model, and performs validation of that other new model. Thus, a number of influencer values to the new model(s) can be successively reduced.

If the new model is not validated 138, at 140 the cumulative contribution threshold is reduced. Iterating back to 122, this reduction in the threshold serves to loosen dependence of the new model upon particular influencer variables, and thereby opens up the size of the remaining set of possible influencer variables that would otherwise be excluded.

Output 142 of the selection engine, is a set of selected influencer variables 144 for a new model, that set of selected variables being smaller than the original set of influencer variables. However, validation of the new model ensures its continued accuracy and therefore justifies reliance upon the new model to accurately forecast behavior while consuming fewer system resources (e.g., processing, memory, and/or bandwidth).

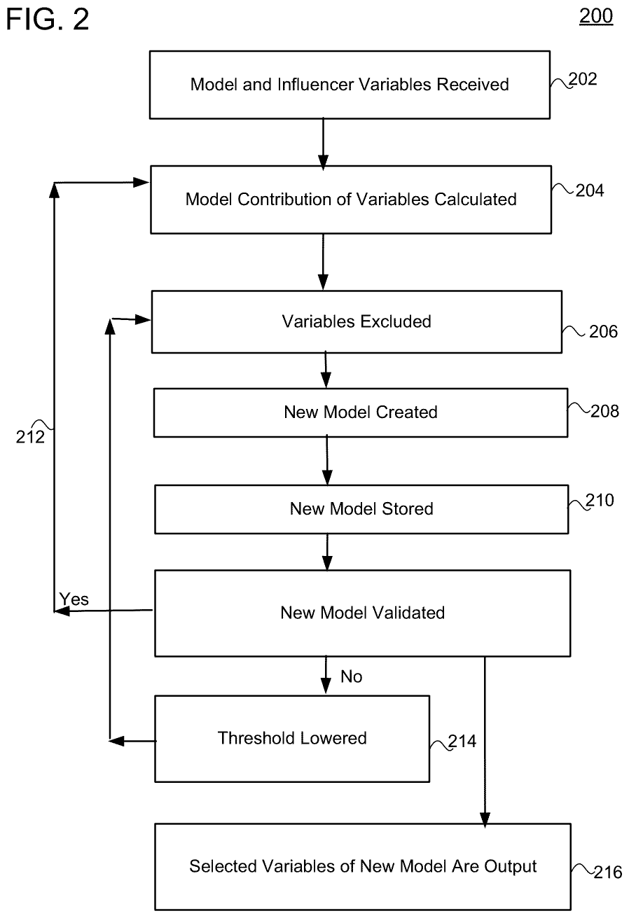

FIG. 2 is a flow diagram of a method 200 according to an embodiment. At 202 an original time series forecasting model and an original set of influencer variables is received.

At 204, contributions of the original set of influencer variables to the original time series forecasting model are calculated. At 206 influencer variables falling below a cumulative contribution threshold are excluded.

At 208 a first new time series forecasting model is created from remaining influencer variables. At 210 the first new time series forecasting model is stored in a non-transitory computer readable storage medium.

If the new time series forecasting model is valid based upon a performance horizon, at 212 iterating to further reduce a number of influencer variables and generate another new time series forecasting model.

If the new time series forecasting model is not valid based upon the performance horizon, at 214 lowering the cumulative contribution threshold to exclude fewer of the original set of influencer variables in order to generate another new time series forecasting model.

At 216 outputting a selected set of influencer variables for the other new time series forecasting model.

Further details regarding time series variable selection according to various embodiments, are now provided in connection with the following examples. These particular examples consider optimization of the SAP Analytics Cloud Time Series Forecasting model available from SAP SE of Walldorf, Germany.

### Example 1

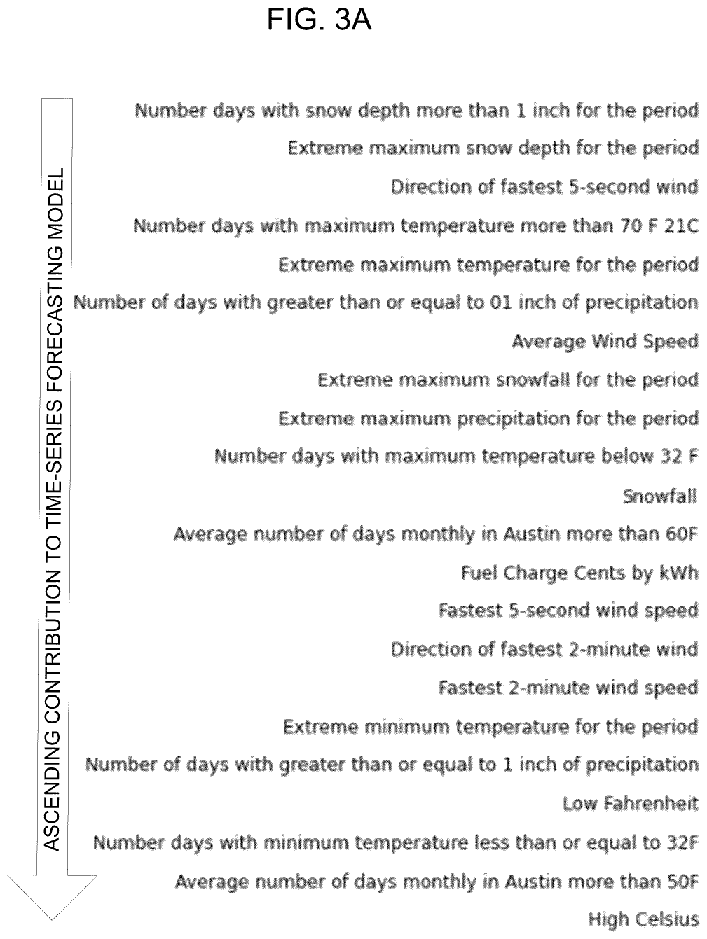

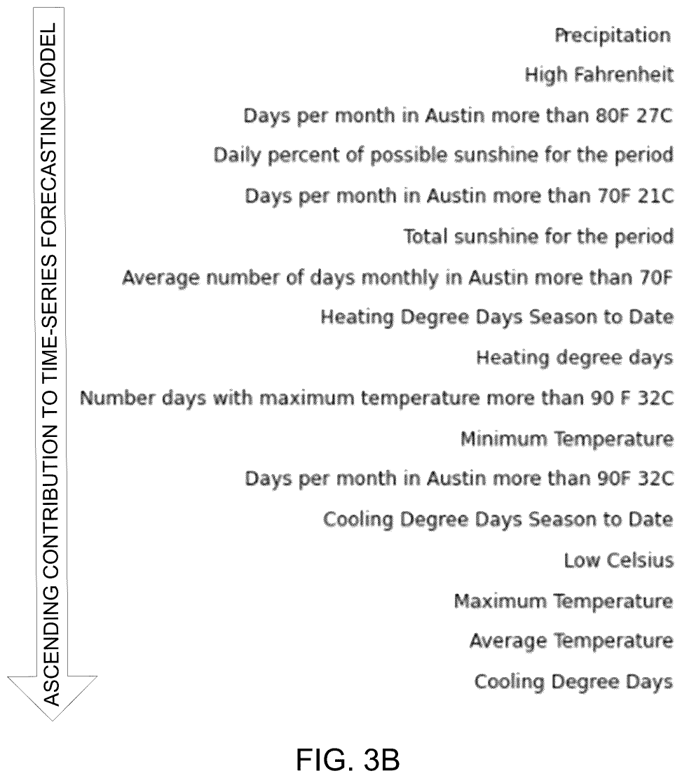

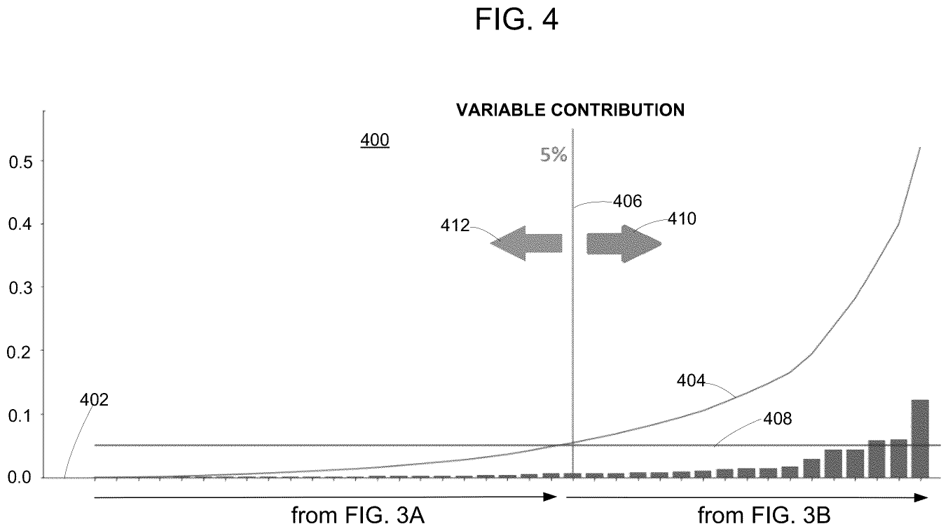

In this first example, the time series forecasting model relates to weather prediction. FIGS. 3A-3B list a total of thirty-nine (39) original influencer variables to that time series forecasting model, arranged in increasing order of contribution to the model.

FIG. 4 shows an overview of the application of two phase variable selection in this first example. The influencer variables are arrayed along the x-axis of this figure, in order of ascending contribution.

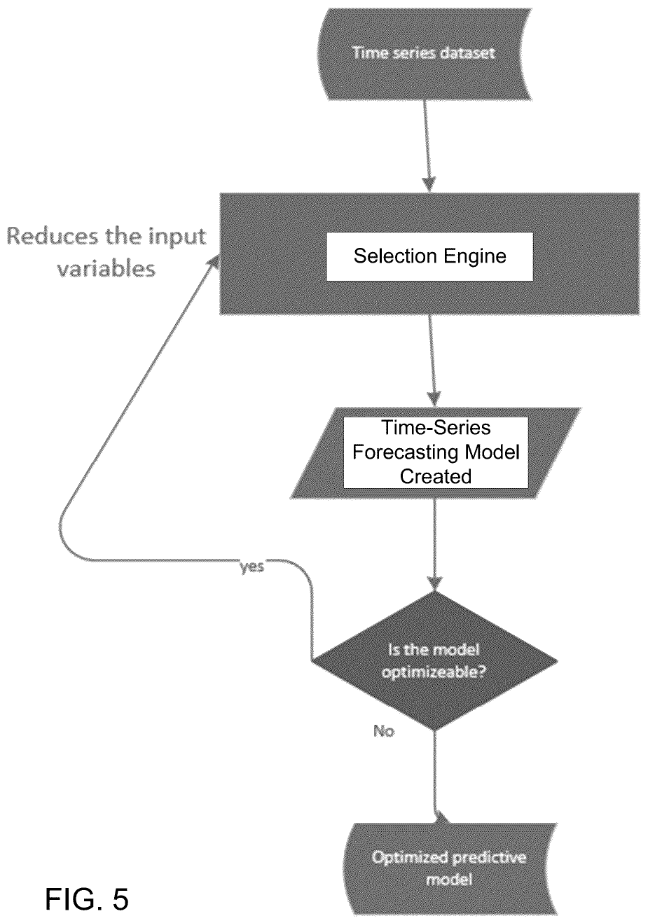

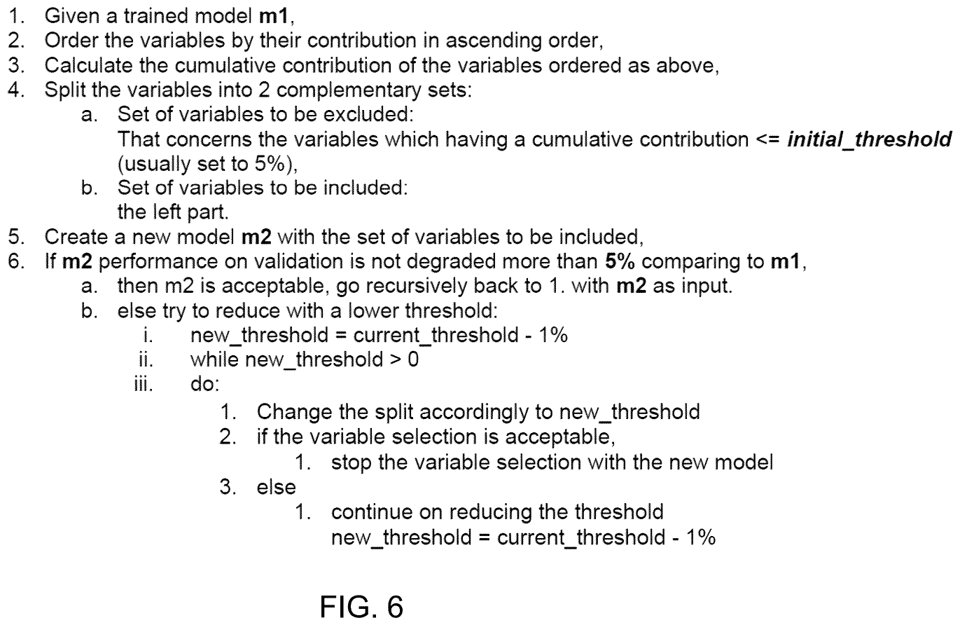

After the forecasting model is trained, the variable selection procedure operates iteratively to reduce the number of influencer variables. This variable selection procedure is detailed as follows, and is also summarized in FIGS. 5 and 6.

1. Given a trained model m1,
2. Order the variables by their contribution in ascending order,
3. Calculate the cumulative contribution of the variables ordered as above,
4. Split the variables into 2 complementary sets:

a. Set of variables to be excluded:
concerns the variables having a cumulative contribution <= initial_threshold (usually
set to 5%); this is shown on the left hand side of FIG. 4,
b. Set of variables to be included:
this is shown on the right hand side of FIG. 4.

5. Create a new model m2 with the set of variables to be included,
6. If m2 performance on validation is not degraded more than 5% comparing to m1,

a. then m2 is acceptable, go recursively back to 1. with m2 as input.
b. else try to reduce with a lower threshold:

i. new_threshold = current_threshold − 1%
ii. while new_threshold > 0
iii. do:

1. Change the split accordingly to new_threshold
2. if the variable selection is acceptable,

1. stop the variable selection with the new model

3. else

1. continue on reducing the threshold
new_threshold = current_threshold − 1%

Visually, this procedure can be depicted as a two phase scheme shown as 400 in FIG. 4. In that figure, the x-axis 402 represents the original influencer variables ordered by their contributive values (e.g., importance). Line 404 shows the (increasing) cumulative contribution of the influencer variables.

The vertical threshold line 406 is the variable selection (split) sought to be achieved. The horizon line 408 is the acceptable performance (5%) on validation.

The variable selection procedure operates as follows. First, the vertical threshold line is moved 410 to the right, removing as many influencer variables as possible while preserving an acceptable performance impact such that the time series forecasting model remains validated.

Then, when the performance drop limit is reached (by the horizon line 408), we go leftward 412 by lowering the threshold (moving the vertical cutoff line 406 to the left).

Selection of influencer variables thus proceeds in an iterative manner according to the following two phases:
(1) determine model performance; then
(2) change cumulative variable cutoff threshold for new model.

### Example 2

As mentioned above, selection of influencer variables according to embodiments can be improved through the application of regularization. By parameterizing a time-series model with regularization, the contributions of the influencer variables may be impacted.

At least two parameters of regularization are available:
L1 parameter of regularization (lasso); and
L2 parameter of regularization (ridge).

In this second example, a benchmark campaign was conducted. The goal was to empirically determine the optimal values of L1 and L2 on top of our variable selection.

We have a set of 133 time series datasets with influencer variables. The number of influencer variables of a dataset ranges from 2 to 183.

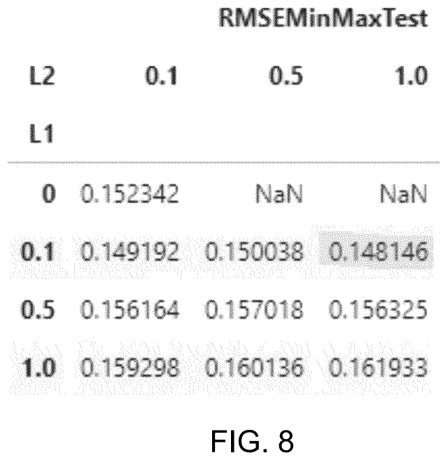

Configurations were compared by combining a grid of regularization values:
L1∈{0.1, 0.5, 1.0}, L2 ∈{0.1, 0.5, 1.0}
   This is shown in FIG. 8.

The table shows the values of the performance metric: “RMSEMinMaxTest”. This performance metric measures the average of the error of prediction.

The lower the value of RMSEMinMaxTest performance metric, the better the model is at prediction. Each cell of the table represents a model that is parameterized with a specific set of values L1 (row), L2 (columns).

A mathematical description of RMSEMinMaxTest is as follows.

$$RMSEinMax = RMSE ( {y}_{{actual}_{scaled}} , {y}_{{predicted}_{scaled}} ) ,$$

$$where : RMSE ( {y}_{actual} , {y}_{pred} ) = \sqrt{( \frac{\sum {( {y}_{actual} - {y}_{pred} )}^{2}}{N} )}$$

$$N = number of points in the test set .$$

$${y}_{\_ scaled} = \frac{y - min ( {y}_{a c tual} )}{max ( {y}_{a c tual} ) - min ( {y}_{a c tual} )}$$

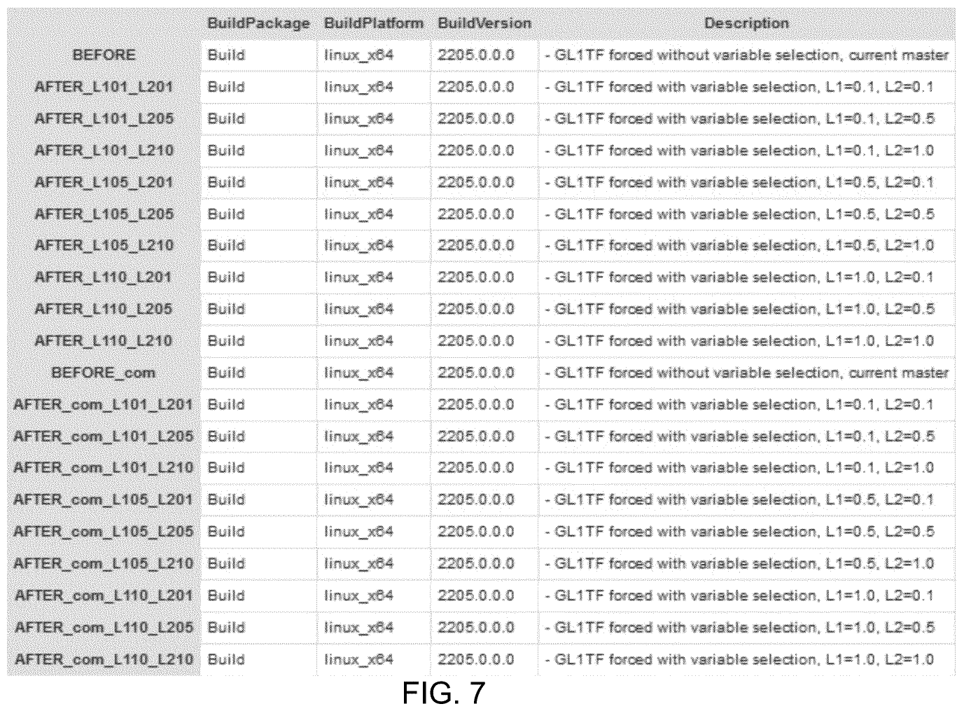

FIG. 7 is a table showing data.
BEFORE: refers to the state of the product before the Variable Selection, i.e. no variable selection, L2=0.1, no L1 regularization.
AFTER_XXX: refers to the state of the product after the Variable Selection, with the specific L1 and L2 values: Piecewise Linear Trend was forced (no model competition).
AFTER_com_xxx: refers to the state of the product after the Variable Selection, with the specific L1 and L2 values. The model competition was allowed.

Performance was evaluated using the “normalized” metric: RMSEMinMaxTest. This metric reflects the model performance on the test set (defined by the last Horizon points of the dataset). It is “normalized” via the “MinMax Scaler” of the true signal.

In some cases, Piecewise Linear Trend is forced. Autoregression (AR) was disabled to avoid the potential cycle being captured by AR.

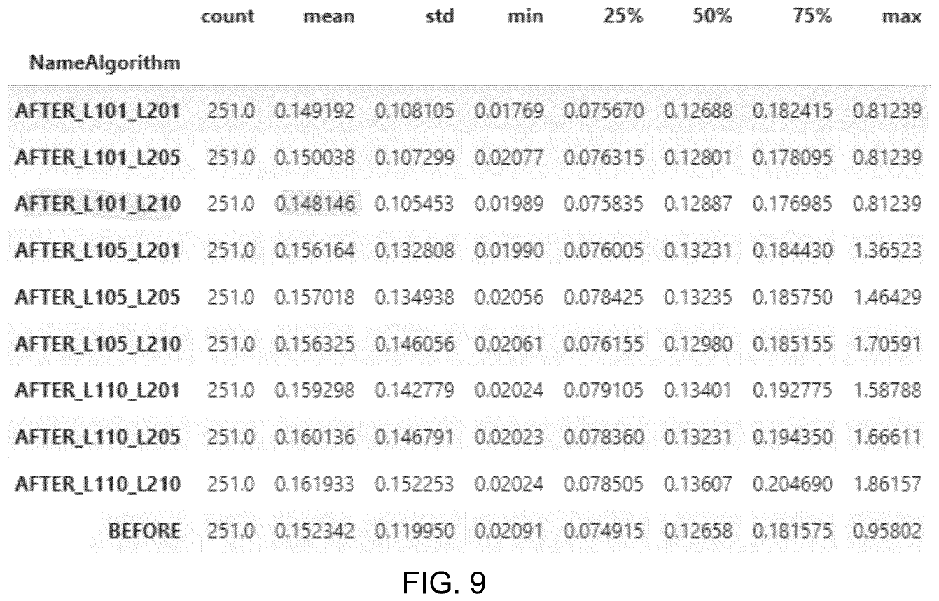

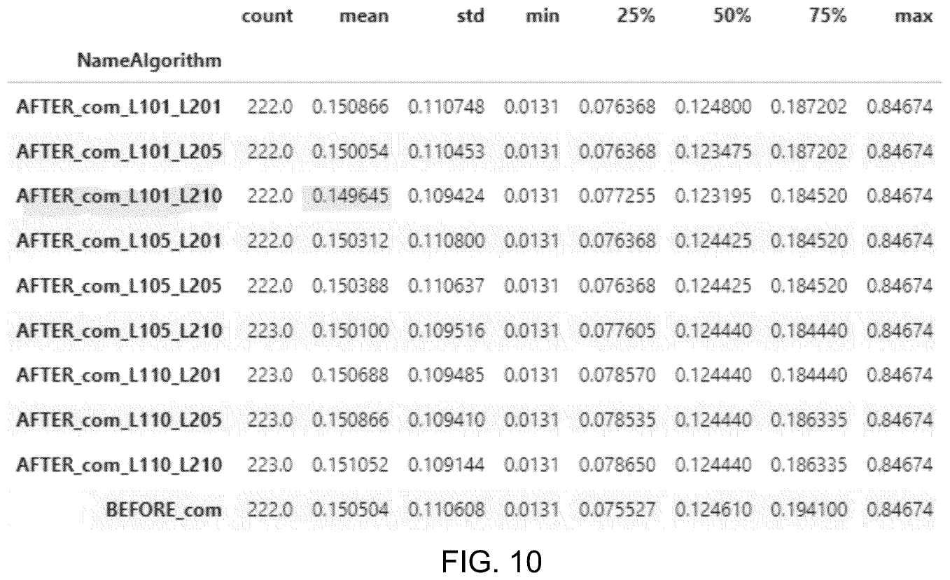

The FIGS. 9 and 10 offer a detailed view of FIG. 8. Each row represents an experiment with a specific setting. The FIG. 8 corresponds to the mean values shown in the FIG. 9 (AFTER_L1xxx_L2XXX).

Highlights of results of the RMSEMinMax Test are as follows.
Best algo in RMSEMinMaxTest mean:
AFTER_L101_L210-0.1481. BEFORE-0.1523. Pct=−2.75%
Best algo in NbKeptVariables mean:
AFTER_L101_L210=2.2112. BEFORE=6.8526. Pct=−67.73%
Best algo in ForecastTime mean:
AFTER_L101_L210=1.2936. BEFORE=1.1603. Pct=+11.49%

In some cases, competition between models was allowed (no forcing). Certain result highlights are listed below.
Best algo in RMSEMinMaxTest mean:
AFTER_com_L101_L210=0.1496. BEFORE_com=0.1505. Pct=−0.57%
Best algo in NbKeptVariables mean:
AFTER_com_L101_L210=1.5270. BEFORE_com=2.2883. Pct=−33.27%
Best algo in ForecastTime mean:
AFTER_com_L101_L210=5.0309. BEFORE_com=4.8144. Pct=+4.50%

For this example, the variable selection is optimal with L1=0.1 and L2=1.0 applied on the influencer variables only. Fourier and Seasonal dummies remain weakly regularized L1=0.05, L2=0.1. If the dataset has no extras, L1 is disabled leaving L2=0.1.

Performance is improved by an average of 2.75% in forced mode, 0.57% in competition mode. The average reduction in the number of extra variables is 67.73% in forced mode, 33.27% in competition mode. The computation time degradation is on average 11.49% in forced mode, 4.50% in competition mode.

Time series forecasting variable selection according to embodiments may offer one or more benefits. Specifically, one possible benefit is flexibility. That is, the procedure simplicity implemented to improve the operation of a time series model, is configurable by a set of parameters accessible to the end-users.

While the above has offered examples of time series forecasting models in the form of elastic-net linear regression or L1-filtering, embodiments are not limited to these particular examples. Embodiments can apply variable selection to models permitting individual evaluation of influencer variable model contribution.

Examples of other types of possible time series forecasting models can include but are not limited to tree based models (such as gradient boosting, random forest, others) using the SHapley Additive explanation (SHAP) values as contribution. Such SHAP values may be generalized to apply to a range of models (including deep learning models).

And while the above has described (optional) regularization in terms of lasso and ridge approaches, embodiments are not limited to these. Other forms of regularization may be employed to convey certain specifics regarding particular time series forecasting models. One possible example could be regularization variants defining a special norm of the vector of parameters (e.g., lasso: norm L1, ridge: norm L2).

Returning now to FIG. 1, there the particular embodiment is depicted with the selection engine as being located outside of the database. However, this is not required.

Rather, alternative embodiments could leverage the processing power of an in-memory database engine (e.g., the in-memory database engine of the HANA in-memory database available from SAP SE), in order to perform one or more various functions as described above, including but not limited to one or more of:
influencer variable contribution calculation;
influencer variable contribution ordering;
influencer variable exclusion;
time-series forecasting model creation;
time series forecasting model validation;
(optional) influencer variable regularization.

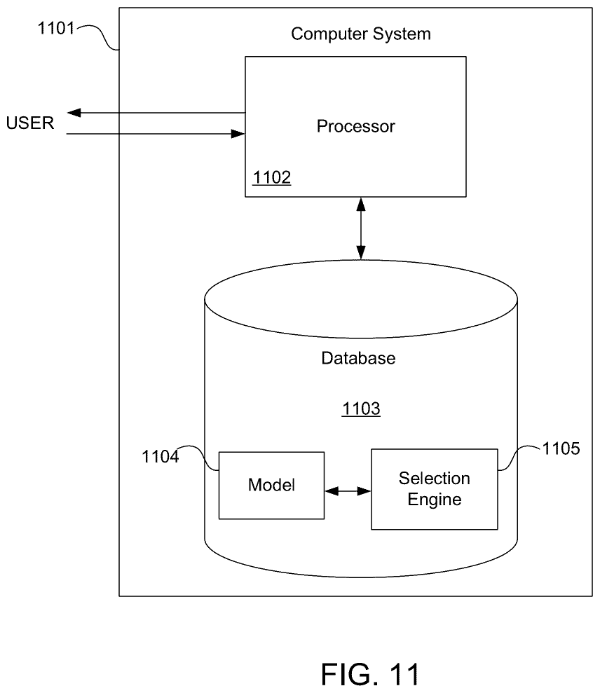

Thus FIG. 11 illustrates hardware of a special purpose computing machine configured to perform influencer variable selection according to an embodiment. In particular, computer system 1101 comprises a processor 1102 that is in electronic communication with a non-transitory computer-readable storage medium comprising a database 1103. This computer-readable storage medium has stored thereon code 1105 corresponding to a selection engine. Code 1104 corresponds to a model. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1. Computer implemented system and methods comprising:
   receiving an original time series forecasting model and an original set of influencer variables;
   calculating contributions of the original set of influencer variables to the original time series forecasting model:
   excluding influencer variables falling below a cumulative contribution threshold;
   creating a first new time series forecasting model from remaining influencer variables:
   storing the first new time series forecasting model in a non-transitory computer readable storage medium;
   if the new time series forecasting model is valid based upon a performance horizon, iterating to further reduce a number of influencer variables and generate another new time series forecasting model;
   if the new time series forecasting model is not valid based upon the performance horizon, lowering the cumulative contribution threshold to exclude fewer of the original set of influencer variables in order to generate another new time series forecasting model: and outputting a selected set of influencer variables for the another new time series forecasting model.
Example 2. The computer implemented system and method of Example 1 wherein the original time series forecasting model is elastic-net linear regression.
Example 3. The computer implemented system and method of Example 1 wherein the original time series forecasting model is L1 trend filtering.
Example 4. The computer implemented system and method of Examples 1, 2, or 3 further comprising subjecting influencer variables to regularization prior to calculating the contributions.
Example 5. The computer implemented system and method of Example 4 wherein the regularization is lasso.
Example 6. The computer implemented system and method of Example 4 wherein the regularization is ridge.
Example 7. The computer implemented system and method of Examples 4, 5, or 6 wherein:
   the non-transitory computer readable storage medium comprises an in-memory database: and an in-memory database engine of the in-memory database performs the regularization.
Example 8. The computer implemented system and method of Examples 1, 2, 3, 4, 5, 6, or 7 wherein:
   the non-transitory computer readable storage medium comprises an in-memory database: and an in-memory database engine of the in-memory database determines if the new time series forecasting model is valid.
Example 9. The computer implemented system and method of Examples 1, 2, 3, 4, 5, 6, 7, or 8 wherein:
   the non-transitory computer readable storage medium comprises an in-memory database: and an in-memory database engine of the in-memory database calculates the contribution.
Example 10. The computer implemented system and method of Examples 1, 2, 3, 4, 5, 6, 7, 8, or 9 wherein:
   the non-transitory computer readable storage medium comprises an in-memory database: and an in-memory database engine of the in-memory database generates the new time series forecasting model.

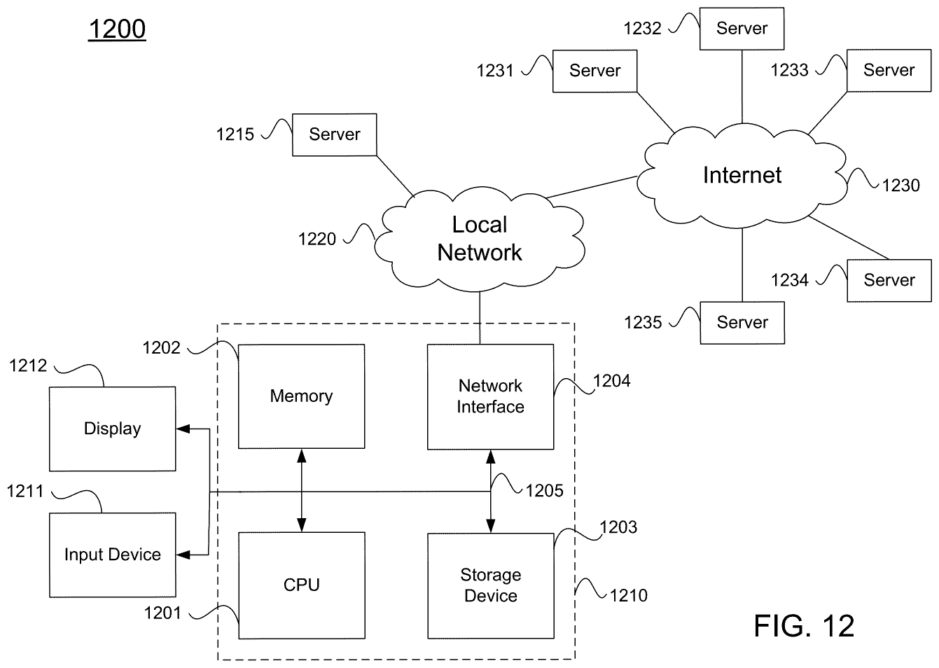

An example computer system 1200 is illustrated in FIG. 12. Computer system 1210 includes a bus 1205 or other communication mechanism for communicating information, and a processor 1201 coupled with bus 1205 for processing information. Computer system 1210 also includes a memory 1202 coupled to bus 1205 for storing information and instructions to be executed by processor 1201, including information and instructions for performing the techniques described above, for example. This memory may also be used for storing variables or other intermediate information during execution of instructions to be executed by processor 1201. Possible implementations of this memory may be, but are not limited to, random access memory (RAM), read only memory (ROM), or both. A storage device 1203 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1203 may include source code, binary code, or software files for performing the techniques above, for example. Storage device and memory are both examples of computer readable mediums.

Computer system 1210 may be coupled via bus 1205 to a display 1212, such as a Light Emitting Diode (LED) or liquid crystal display (LCD), for displaying information to a computer user. An input device 1211 such as a keyboard and/or mouse is coupled to bus 1205 for communicating information and command selections from the user to processor 1201. The combination of these components allows the user to communicate with the system. In some systems, bus 1205 may be divided into multiple specialized buses.

Computer system 1210 also includes a network interface 1204 coupled with bus 1205. Network interface 1204 may provide two-way data communication between computer system 1210 and the local network 1220. The network interface 1204 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1204 sends and receives electrical, electromagnetic, or optical signals that carry digital data streams representing various types of information.

Computer system 1210 can send and receive information, including messages or other interface actions, through the network interface 1204 across a local network 1220, an Intranet, or the Internet 1230. For a local network, computer system 1210 may communicate with a plurality of other computer machines, such as server 1215. Accordingly, computer system 1210 and server computer systems represented by server 1215 may form a cloud computing network, which may be programmed with processes described herein. In the Internet example, software components or services may reside on multiple different computer systems 1210 or servers 1231-1235 across the network. The processes described above may be implemented on one or more servers, for example. A server 1231 may transmit actions or messages from one component, through Internet 1230, local network 1220, and network interface 1204 to a component on computer system 1210. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving an original time series model and an original set of variables;
calculating contributions of the original set of variables to the original time series model;
excluding variables falling below a cumulative contribution threshold;
creating a first new time series model from remaining variables;
storing the first new time series model in a non-transitory computer readable storage medium;
if the new time series model is valid based upon a performance horizon, iterating to further reduce a number of variables and generate another new time series model;
if the new time series model is not valid based upon the performance horizon, lowering the cumulative contribution threshold to exclude fewer of the original set of variables in order to generate another new time series model; and
outputting a selected set of influencer variables for the another new time series model.

2. A method as in claim 1 wherein the original time series model is elastic-net linear regression.

3. A method as in claim 1 wherein the original time series model is L1 trend filtering.

4. A method as in claim 1 further comprising subjecting variables to regularization prior to calculating the contributions.

5. A method as in claim 4 wherein the regularization is lasso.

6. A method as in claim 4 wherein the regularization is ridge.

7. A method as in claim 4 wherein:
the non-transitory computer readable storage medium comprises an in-memory database; and
an in-memory database engine of the in-memory database performs the regularization.

8. A method as in claim 1 wherein:
the non-transitory computer readable storage medium comprises an in-memory database; and
an in-memory database engine of the in-memory database determines if the new time series model is valid.

9. A method as in claim 1 wherein:
the non-transitory computer readable storage medium comprises an in-memory database; and
an in-memory database engine of the in-memory database calculates the contribution.

10. A method as in claim 1 wherein:
the non-transitory computer readable storage medium comprises an in-memory database; and
an in-memory database engine of the in-memory database generates the new time series model.

11. A non-transitory computer readable storage medium embodying a computer program for performing a method, said method comprising:
receiving an original time series model and an original set of variables;
calculating contributions of the original set of variables to the original time series model;
excluding variables falling below a cumulative contribution threshold;
creating a first new time series model from remaining variables;
storing the first new time series model in a non-transitory computer readable storage medium;
if the new time series model is valid based upon a performance horizon, iterating to further reduce a number of variables and generate another new time series model;
if the new time series model is not valid based upon the performance horizon, lowering the cumulative contribution threshold to exclude fewer of the original set of variables in order to generate another new time series model; and
outputting a selected set of variables for the another new time series model, wherein the method further comprises,
subjecting variables to regularization prior to calculating the contributions.

12. A non-transitory computer readable storage medium as in claim 11 wherein the regularization is lasso.

13. A non-transitory computer readable storage medium as in claim 11 wherein the regularization is ridge.

14. A non-transitory computer readable storage medium as in claim 11 wherein the time series model is elastic-net linear regression.

15. A non-transitory computer readable storage medium as in claim 11 wherein the time series model is L1 trend filtering.

16. A computer system comprising:
one or more processors;
a software program, executable on said computer system, the software program configured to cause an in-memory database engine of an in-memory database to:
receive an original time series model and an original set of variables;
calculate contributions of the original set of variables to the original time series model;
exclude variables falling below a cumulative contribution threshold;
create a first new time series model from remaining variables;
store the first new time series model in a non-transitory computer readable storage medium;
if the new time series model is valid based upon a performance horizon, iterate to further reduce a number of variables and generate another new time series model;
if the new time series model is not valid based upon the performance horizon, lower the cumulative contribution threshold to exclude fewer of the original set of variables in order to generate another new time series model; and
output a selected set of variables for the another new time series model.

17. A computer system as in claim 16 wherein the in-memory database engine is further configured to subject variables to regularization prior to calculating the contributions.

18. A computer system as in claim 17 wherein the regularization comprises lasso or ridge.

19. A computer system as in claim 16 wherein the time series model is L1 trend filtering.

20. A computer system as in claim 16 wherein the time series model is elastic-net linear regression.
